(19) United States
(12) Patent Application Publication
(10) Pub. No.: US 2024/0008386 A1
(43) Pub. Date: Jan. 11, 2024

(54) Mover Device for Autonomous Moving an Agricultural Implement

(71) Applicant: ECO CLIPPER B.V., Sint Nicolaasga (NL)

(72) Inventor: Sybren Yme Leijenaar, Sint Nicolaasga (NL)

(73) Assignee: ECO CLIPPER B.V., Sint Nicolaasga (NL)

(21) Appl. No.: 18/347,656

(22) Filed: Jul. 6, 2023

(30) Foreign Application Priority Data
Jul. 6, 2022 (NL) 2032388

(51) Int. Cl. A01B 69/04; B62D 9/00

(52) U.S. Cl. CPC A01B 69/008; B62D 9/00

(57) ABSTRACT

A mover device is configured to autonomously move an agricultural implement. The mover device includes a frame having a front side, a rear side, and two lateral sides, a motor, and two coaxial driven wheels. Each wheel extends at a respective lateral side of the frame and is driven by the motor for moving the device on a surface in a driving direction. A coupler extends at the rear side of the frame which is arranged for coupling the device to the implement. A three-point hitch attachment device in accordance with any of the international standards ISO 8759, ISO 730 and ISO 11001 extends at the front side of the device for coupling the device to a three-point hitch coupler in accordance with any of the international standards ISO 8759, ISO 730 and ISO 11001 of a tractor.

### CROSS REFERENCES TO RELATED APPLICATIONS

This Non-Provisional patent application claims the benefit of and priority to Netherlands Patent Application Serial No. NL 2032388, filed Jul. 6, 2022, entitled “Mover Device for Autonomous Moving an Agricultural Implement,” the entire contents of which is hereby incorporated herein by reference.

### BACKGROUND

The present invention relates to a mover device for autonomously moving an agricultural implement.

Such a mover device is disclosed in U.S. Pat. No. 11,254,379 B2, and may be used to autonomously drive implements such as a mower device in a field. The mover device may comprise equipment for driving a preprogrammed route and/or for autonomously determining a route in the field.

If it is cumbersome to transport an implement and such a mover device to the field and put it into operation, the time savings are less and sometimes not even worth the effort to have an implement work autonomously. The invention aims at making agricultural implements more easily transportable and autonomously deployable.

### SUMMARY

To this end, a mover device according to the preamble is characterized in that the mover device comprises:
a frame having a front side, a rear side, and two lateral sides;
at least one motor;
two coaxial driven wheels, wherein each wheel extends at a respective lateral side of the frame and is driven by the motor, for moving the device on a surface in a driving direction;
a coupler extending at the rear side of the frame which is arranged for coupling the device to the implement; and
a three-point hitch attachment device in accordance with any of the international standards ISO 8759, ISO 730 and ISO 11001 extending at the front side of the device for coupling the device to a three-point hitch coupler in accordance with any of the international standards ISO 8759, ISO 730 and ISO 11001 of a tractor.

The invention allows for a short-built unit that can be coupled to an implement by means of the standard 3-point coupler or an integrated specific coupling of the implement. The moving device and the implement may be permanently or detachably coupled. The mover device has two driven wheels with which the implement can be pushed or pulled and the mover device can steer due to speed differences between the wheels. In order to easily transport the mover device with the implement, a standard 3-point attachment is provided on the opposite side of the implement to be able to lift and transport the mover and implement as a whole from the ground with the lifting device of an agricultural tractor.

It should be noted that the mover device can normally be used to pull and push an agricultural implement and is normally arranged to drive in both directions, so that the terms “front side” and “rear side” are chosen arbitrary and do not suggest a fixed driving direction of the mover device.

The three-point hitch attachment device may be provided as a separate adapter device, such as a linkage triangle for rapid coupling and uncoupling of tools (also known as a three-point Accord™ A frame linkage) or other three-point adapter device, which may be detachably be connected to the mover device. To that end the mover device is provided with a suitable coupler for connecting the respective Accord™ A frame linkage, or other adapter device.

According to a preferred embodiment, the coupler is arranged for coupling the device to the implement in such a manner that mutual rotation around at least a vertical axis between the mover device and the implement is substantially not possible.

According to an alternative preferred embodiment, the coupler is arranged for coupling the device to the implement in such a manner that mutual rotation around the vertical axis is possible, and that mutual rotation between the mover device and the implement around a horizontal axis perpendicular to the driving direction is substantially not possible.

According to a preferred embodiment, the coupler extending at the rear side of the frame is a three-point hitch coupler in accordance with any of the international standards ISO 8759, ISO 730 and ISO 11001 for coupling the device to a three-point hitch attachment device in accordance with any of the international standards ISO 8759, ISO 730 and ISO 11001 on the implement.

Preferably, the mover device comprises two motors, wherein each wheel is driven by a respective motor.

Preferably, the mover device comprises a battery or a generator set for powering the motor and/or other electronic devices of the mover device and/or the agricultural implement.

The agricultural implement may be fed by said battery or generator set via a power take-off (PTO) connector mounted on the mover device.

Preferably, the mover device comprises an operating unit arranged to autonomously drive and steer the mover device.

Preferably, the mover device comprises sensors connected to the operating unit to detect obstacles and/or to determine the location of the mover device.

Preferably, the mover device comprises at least one hydraulic conduit between the front side and the rear side of the frame with front and rear hydraulic couplings in accordance with the international standard ISO 5675 arranged to transmit hydraulic power from the tractor to the agricultural implement via the conduit.

The hydraulic connection of the tractor is used to be able to fold the implement and possibly stabilize it for transport. There may be as many hydraulic conduits provided on the mover device as needed for the particular implement. As a result, the unit itself does not need to have a hydraulic pump.

Preferably, the mover device comprises a footrest and/or a seat at the front side of the mover device, and a manual control unit, such that an operator is able to manually drive and steer the mover device.

Preferably, the centre of gravity of the mover device is located between the vertical plane through the axis of the wheels and the rear side of the frame.

this is to ensure that the implement is not lifted from the ground by the mover device. The weight may be close to said vertical plane, or closer to the implement coupler, if more pressure on the implement is desired.

Preferably, the mover device comprises a parking brake for braking the wheels and a sensor for detecting if the mover device is coupled to a tractor, wherein the operating unit is arranged such that the parking brake is released if the sensor detects that the moving device is coupled to a tractor, and the parking brake is activated if the sensor detects that the moving device is disconnected from a tractor.

Preferably, the weight of the mover device is less than 2000 kg, preferably less than 1500 kg.

The weight of the mover device is preferably such that it can be stably lifted together with the agricultural implement by most tractors that are designed for lifting said agricultural elements. The design of the mover device is further preferably such that it can be manipulated by humans, for instance to rotate the device around the wheel axis between a position where it is lying on its side and an upright position. Also means may be provided on the mover device to keep the mover device in an upright position, such as a third wheel or possible fourth wheel which can be folded out at one or both sides when the mover device is not attached to a tractor or an agricultural implement, or balancing equipment as used in two-wheeled self-balancing scooters/hoverboards.

Finally, the present invention relates to method for moving an agricultural implement, wherein a mover device in accordance with any of the previous claims is coupled to a tractor for transporting the moving device and the moving device is coupled to the agricultural implement for autonomously driving the agricultural implement.

### BRIEF DESCRIPTION OF THE DRAWINGS

The present invention will now be illustrated with reference to the drawing where

FIGS. 1A, 1B are a perspective front view and a top view respectively of a first embodiment of a mover device;

FIGS. 2A, 2B, 2C are a perspective front view, a rear view and a side view respectively of a second embodiment of a mover device;

FIG. 3 a perspective front view of a second embodiment of a mover device; and

FIG. 4 is a side view of a tractor while transporting the mover device together with an agricultural implement.

### DETAILED DESCRIPTION

According to the figures the mover device comprises a frame 101 in the form of a substantially closed housing, two parallel driven wheels 102 at the lateral sides, an implement coupler 103, 103′ at the rear side for attaching and lifting an implement such as a mowing device 150, and a tractor attachment device 104 at the front side for being attached to and lifted by a tractor (not shown).

Inside the housing may be located a motor for driving each wheel 102 in at individually controllable speeds, a battery, power pack or generator, an operating unit for autonomously driving and steering the mover device. The wheels are in principal coaxial, but are coupled to each other such that they are allowed to move vertically in opposite directions, so as to always engage the ground in uneven terrain such as a farm field.

The mover device may further comprise sensors connected to the operating unit to detect obstacles in the field and/or to determine the location of the mover device in the field. The mover device may also comprise a footrest 105 at the front side, and a manual control unit 106, such that an operator is able to manually drive and steer the mover device.

The mover device may furthermore comprise a hydraulic conduit between the front side and the rear side of the frame with front and rear hydraulic couplings, in accordance with the international standard ISO 5675, arranged to transmit hydraulic power from the tractor to the agricultural implement 150 via the conduit.

The tractor attachment device 104 at the front side is a three-point hitch attachment device in accordance with any of the international standards ISO 8759, ISO 730 and ISO 11001, such that the moving device can be engaged by standard three-point hitch couplers of tractors. Such a hitch attachment device may comprise a hitch linkage 141, a central upper hatch pin arrangement 142 and two spaced apart lower hatch pin arrangements 143.

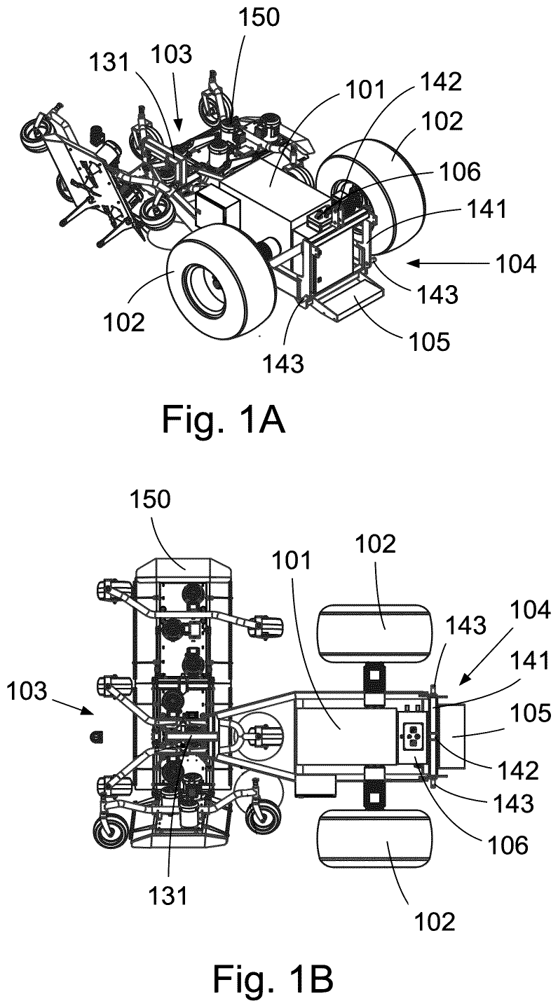

According to the embodiment as shown in FIGS. 1A and 1B the implement coupler 103 at the rear side is an implement specific coupling device, in this case for a mowing device 150. It comprises a drawbar 131 which is rigidly connected to the frame 101 of the moving device, and which drawbar 131 comprises a coupling arrangement at its end which is hingedly connected to a matching hatch pin arrangement of the mowing device, such that the mowing device can be lifted by upward movement of the drawbar 131, whereas the mowing device 150 is allowed to rotate around a horizontal hinge axis of the hatching pin which extends perpendicular to the driving direction.

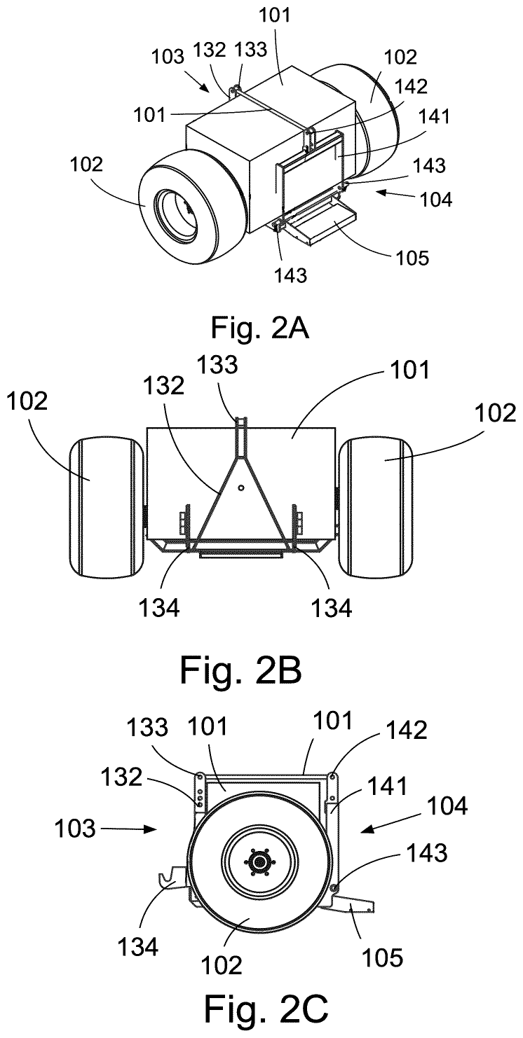

According to the embodiment as shown in FIGS. 2A, 2B and 2C the implement coupler 103 at the rear side is a three-point hitch coupler in accordance with any of the international standards ISO 8759, ISO 730 and ISO 11001, such that the moving device can be coupled to standard three-point hitch attachment devices of agricultural implements. Such a hitch coupler may comprise a hitch linkage 132, and for instance a central upper hatch eye 133 and two spaced apart lower hatch hooks 134. The rear side may be provided with a power take-off (PTO) connector for feeding the implement 150, shown in FIG. 2B in the centre of the rear side within the triangle of the linkage 132, seen from the rear.

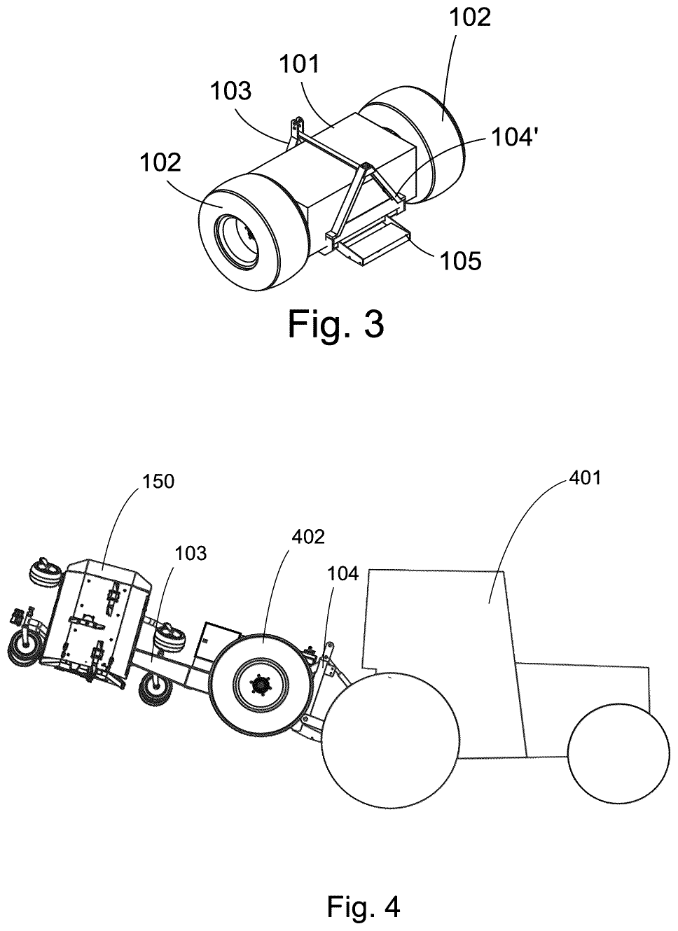

According to FIG. 3 the three-point hitch attachment device 104 may be provided as a separate adapter device, such as the three-point Accord™ A frame linkage triangle 104′ as shown in FIG. 3, or other universal three-point adapter device. The adapter device 104′ may be detachably be connected to the mover device, and the mover device may be provided with a suitable coupler for connecting the adapter device 104′.

FIG. 4 shows a tractor 401 which is coupled to the mover device 402, which in turn is coupled to a mowing device 150.

The working method may be as follows. The mover device 402 is coupled by an operator to the implement 150. The tractor 401 then is operated to engage the mover device 402 by means of the three-point hitch coupler. The mowing device 150 is folded by means of the hydraulic coupling and the hydraulic conduit of the mover device 402. The tractor then lifts the mover device 402 with the mowing device 150 from the ground, as shown in FIG. 4. The operator drives the combination to the field to be worked. The mover device 402 with the implement 150 is put down at or near the starting position, the mowing device 150 is unfolded by means of the hydraulic coupling with the tractor, and the mover device 402 is uncoupled from the tractor 401. The tractor 401 is moved out of the way and the operator activates the mover device 402 for automatic mowing of the field. If necessary, the operator can first drive the mover device 402 to a starting position using the manual control unit 106. The tractor 401 can then be used for other tasks, or the operator can drive the tractor 401 home and pick up the mover device 402 with the mowing device 150 once it has finished mowing the field.

The invention has thus been described by means of preferred embodiments. It is to be understood, however, that this disclosure is merely illustrative. Various details of the structure and function were presented, but changes made therein, to the full extent extended by the general meaning of the terms in which the appended claims are expressed, are understood to be within the principle of the present invention. The description and drawings shall be used to interpret the claims. The claims should not be interpreted as meaning that the extent of the protection sought is to be understood as that defined by the strict, literal meaning of the wording used in the claims, the description and drawings being employed only for the purpose of resolving an ambiguity found in the claims. For the purpose of determining the extent of protection sought by the claims, due account shall be taken of any element which is equivalent to an element specified therein. An element is to be considered equivalent to an element specified in the claims at least if said element performs substantially the same function in substantially the same way to yield substantially the same result as the element specified in the claims.

1. A mover device for autonomously moving an agricultural implement, wherein the mover device comprises:
a frame having a front side, a rear side, and two lateral sides;
at least one motor;
two coaxial driven wheels, wherein each wheel extends at a respective lateral side of the frame and is driven by the motor, for moving the device on a surface in a driving direction;
a coupler extending at the rear side of the frame which is arranged for coupling the device to the implement; and
a three-point hitch attachment device in accordance with any of the international standards ISO 8759, ISO 730 and ISO 11001 extending at the front side of the device for coupling the device to a three-point hitch coupler in accordance with any of the international standards ISO 8759, ISO 730 and ISO 11001 of a tractor.

2. The mover device of claim 1, wherein the coupler is arranged for coupling the device to the implement in such a manner that mutual rotation around at least a vertical axis between the mover device and the implement is substantially not possible.

3. The mover device of claim 2, wherein the coupler is arranged for coupling the device to the implement in such a manner that mutual rotation around the vertical axis is possible, and that mutual rotation between the mover device and the implement around a horizontal axis perpendicular to the driving direction is substantially not possible.

4. The mover device of claim 3, wherein the coupler extending at the rear side of the frame is a three-point hitch coupler in accordance with any of the international standards ISO 8759, ISO 730 and ISO 11001 for coupling the device to a three-point hitch attachment device in accordance with any of the international standards ISO 8759, ISO 730 and ISO 11001 on the implement.

5. The mover device of claim 4, wherein the mover device comprises two motors, wherein each wheel is driven by a respective motor.

6. The mover device of claim 5, wherein the mover device comprises a battery or a generator set for powering the motor and/or other electronic devices of the mover device and/or the agricultural implement.

7. The mover device of claim 6, wherein the mover device comprises an operating unit arranged to autonomously drive and steer the mover device.

8. The mover device of claim 7, wherein the mover device comprises sensors connected to the operating unit to detect obstacles and/or to determine the location of the mover device.

9. The mover device of claim 8, wherein the mover device comprises at least one hydraulic conduit between the front side and the rear side of the frame with front and rear hydraulic couplings in accordance with the international standard ISO 5675 arranged to transmit hydraulic power from the tractor to the agricultural implement via the conduit.

10. The mover device of claim 9, wherein the mover device comprises a footrest and/or a seat at the front side of the mover device, and a manual control unit, such that an operator is able to manually drive and steer the mover device.

11. The mover device of claim 10, wherein the centre of gravity of the mover device is located between the vertical plane through the axis of the wheels and the rear side of the frame.

12. The mover device of claim 11, wherein the mover device comprises a parking brake for braking the wheels and a sensor for detecting if the mover device is coupled to a tractor, wherein the operating unit is arranged such that the parking brake is released if the sensor detects that the moving device is coupled to a tractor, and the parking brake is activated if the sensor detects that the moving device is disconnected from a tractor.

13. The mover device of claim 12, wherein the weight of the mover device is less than 2000 kg, preferably less than 1500 kg.

14. A method for moving an agricultural implement using a movable device, wherein the mover device comprises:
a frame having a front side, a rear side, and two lateral sides;
at least one motor;
two coaxial driven wheels, wherein each wheel extends at a respective lateral side of the frame and is driven by the motor, for moving the device on a surface in a driving direction;
a coupler extending at the rear side of the frame which is arranged for coupling the device to the implement; and
a three-point hitch attachment device in accordance with any of the international standards ISO 8759, ISO 730 and ISO 11001 extending at the front side of the device for coupling the device to a three-point hitch coupler in accordance with any of the international standards ISO 8759, ISO 730 and ISO 11001 of a tractor, and
wherein the mover device is coupled to a tractor for transporting the moving device and the moving device is coupled to the agricultural implement for autonomously driving the agricultural implement.
